(19) United States
(12) Patent Application Publication
(10) Pub. No.: US 2026/0361950 A1
(43) Pub. Date: Nov. 12, 2026

(54) SYSTEMS AND METHODS FOR CONTENT STITCHING BASED ON METADATA INDICATING ATTRIBUTES OF CONTENT ELEMENTS

(71) Applicant: DISH Network Technologies India Private Limited, Bangalore (IN)

(72) Inventors: Arunoday Thammineni, Bengaluru (IN); Kunal Kini K, Bangalore (IN); Abhiram Gaddemane Krishnamurthy, Bangalore (IN); Kartik Kannojiya, Haldwani (IN)

(21) Appl. No.: 19/203,677

(22) Filed: May 9, 2025

(51) Int. Cl. H04N 21/44

(52) U.S. Cl. CPC H04N 21/44016

(57) ABSTRACT

Systems and methods for stitching additional content to content streams is described herein. A content stream stitching system detects that first additional content is to be stitched to a content stream. The content stream stitching system identifies metadata indicating attributes of content elements included in the first additional content. The content stream stitching system determines whether to stitch the additional content to the content stream based on the metadata and one or more content criterions. The content stream stitching system stitches the additional content to the content stream based on the determination of whether the additional content is to be stitched into the content stream.

### BACKGROUND

Content stream providers, such as entities that provide audio, visual, video, etc., streaming content, provide media content to user devices via

a content stream. The user devices may be televisions, computers, content receivers, phones, tablets, or other types of user devices. A content stream provider may stitch additional content (i.e. other media content, advertisements, sports recaps, breaking newscasts, emergency weather alerts, a message from a content stream provider, other types of content, etc.) into the content stream, such as by identifying a section of a content stream and inserting the additional content into the content stream at that section. In order to ensure that loading times for content and additional content are minimized, content stream providers typically include additional content without first determining whether the additional content is suitable to be provided with other media content included in the content stream.

### BRIEF SUMMARY

The embodiments disclosed herein improve the technology of content stream providers by providing a technical solution that improves the ability of content stream providers to determine which additional content is to be stitched into a content stream. The embodiments disclosed herein may identify metadata associated with attributes of elements of additional content that is to be stitched to a content stream. The embodiments disclosed herein may identify one or more content criterions for stitching additional content to the content stream. The embodiments disclosed herein may determine whether to stitch additional content to a content stream based on the one or more content criterions and the identified metadata.

In some embodiments, a content stream stitching system may detect that first additional content is to be stitched to a content stream. The content stream stitching system may generate metadata for the first additional content based on a text description of at least a portion of the first additional content. In some embodiments, the content stream stitching system generates metadata for the first additional content by applying one or more machine learning models to the text description. The content stream stitching system may identify one or more content criterions for stitching content to the content stream. The content stream stitching system may determine whether the first additional content is to be stitched to the content stream based on the one or more criterions and the metadata. Based on the determination of whether the first additional content is to be stitched to the content stream, the content stream stitching system may stitch the first additional content to the content stream, prevent the first additional content from being stitched to the content stream, stitch the first additional content to the content stream at different location within the content stream than the location at which the first additional content was originally meant to be stitched to the content stream, or some combination thereof.

In some embodiments, a text description of the first additional content is generated based on textual elements, audio elements, visual elements, other elements of the first additional content, or some combination thereof. The content stream stitching system may generate first text based on the text elements, audio elements, or other elements of the first additional content. The content stream stitching system may generate second text based on the visual elements by applying a first machine learning model configured to generate text based on one or more images, videos, video frames, etc. The context stream stitching system may generate metadata indicating attributes of elements of the first additional content by applying a second machine learning model to the first text, second text, or some combination thereof.

In some embodiments, the content stream stitching system determines whether metadata associated with the first additional content, such as metadata indicating attributes of one or more elements of the first additional content, has already been generated. In such embodiments, the content stream stitching system may generate a unique identifier for the first additional content, such as based on an indication of a content provider from which the first additional content was received, a value generated based on data included in the first additional content (e.g. a checksum generated based on at least a portion of the first additional content), other data associated with the first additional content, or some combination thereof. In some embodiments, the content stream stitching system determines whether metadata associated with the first additional content has already been generated by accessing a data store, such as a database, that includes unique identifiers associated with additional content and metadata associated with the additional content.

In some embodiments, based on a determination that metadata is to be generated for the first additional content, the content stream stitching system identifies second additional content. In such embodiments, the second additional content may be stitched to the content stream in place of the first additional content. In some embodiments, metadata is generated for the first additional content during a time period during which a user device is to play the second additional content.

### BRIEF DESCRIPTION OF THE DRAWINGS

FIG. 1 is a display diagram depicting a sample environment in which a content stream stitching system operates, according to various embodiments described herein.

FIG. 2 is a block diagram depicting example components incorporated in a content stream stitching system, according to various embodiments described herein.

FIG. 3 is a data flow diagram depicting a sample data flow for generating metadata for additional content that is to be stitched into a content stream, according to various embodiments described herein.

FIG. 4 is a flow diagram of a process for stitching additional content into a content stream based on one or more content criterions, according to various embodiments described herein.

FIG. 5 is a flow diagram of a process for causing second additional content to be stitched into a content stream while metadata is being generated for first additional content, according to various embodiments described herein.

### DETAILED DESCRIPTION

Content stream providers – such as audio streaming services, video streaming services, other types of streaming services, or some combination thereof – typically provide content streams including media content to user devices. The content stream providers may adjust the content streams to include additional content at one or more selected locations within the content stream, such as by stitching content streams to include the additional content at the one or more selected locations. The additional content may be received from one or more content providers. The video streaming service may adjust the content stream such that the additional content is played while the media content is paused or stopped. For example, a video streaming service (i.e., the content stream provider) may select one or more locations (e.g. timestamps) within which media content (i.e., the content stream) is to pause or stop for a selected period of time, and different content (i.e., the additional content), such as informational content, advertisements, other types of content, or some combination thereof, is to be played instead of the media content for the selected period of time.

However, conventional video streaming services, and more generally conventional content stream providers, are not able to determine whether the additional content is appropriate to be inserted (i.e. “stitched”) into the content stream. Stitching additional content into a content stream may include identifying one or more points within the content stream and inserting additional content into the content stream, such that the additional content is presented before the remainder of the content in the content stream is presented. This results in conventional content stream providers providing additional content that a consumer of the media content may not wish to consume. For example, the additional content may be in a language that the consumer does not understand, or it may be in a language that does not match the media content being consumed, etc. As another example, the additional content may be inappropriate for the age of the consumer, such as an alcohol or tobacco advertisement being presented during a children’s program. As yet another example, the additional content may be repeated, such that a consumer is forced to view or hear the same additional content multiple times before the media content resumes playing. As a further example, the additional content may be content that is not meant to be viewed within the same content break, adjacent to other additional content, etc., as other additional content of a selected type (e.g. an advertisement for one automobile company being displayed immediately after an advertisement for a competing automobile company).

While some conventional content stream providers may attempt to determine whether additional content is appropriate to be inserted into a content stream, such content streaming services are unable to do so while the content stream is being transmitted to a device, or to do so within a reasonable amount of time to result in acceptable content loading times for consumers. Such conventional content streaming services are unable to make this determination because they analyze every aspect of the additional content before determining whether to insert additional content into a content stream each time the additional content is to be inserted into a content stream. Additional content is typically received “on demand” in response to a request for the additional content at the time a content break occurs. As a result, conventional content stream providers are unable to verify whether additional content is suitable for inclusion into the content stream without subjecting the consumer to long loading times as a result of the large amount of computing resources needed for conventional content stream providers to make this verification.

The embodiments disclosed herein improve the technology of content stream providers by providing a technical solution that quickly identifies metadata for additional content and determines whether the additional content is to be inserted into a content stream based on one or more content criterions. The embodiments disclosed herein may identify metadata indicating attributes of elements of the additional content by generating a text description of at least a portion of the additional content and applying a machine learning model configured to generate metadata indicating attributes of elements of the additional content to the text description. The embodiments disclosed herein may use the identified metadata and one or more content criterions to determine whether the additional content is to be stitched into the content stream. The embodiments disclosed herein may play second additional content in place of the additional content while metadata associated with the additional content is identified. The embodiments disclosed herein may generate a unique identifier for additional content for which metadata has been generated and may determine whether metadata for the additional content has already been generated based on the unique identifier.

Thus, the embodiments disclosed herein are able to determine whether additional content is appropriate to be stitched into a content stream more quickly than conventional content stream providers. For example, by generating an identifier for additional content and storing metadata associated with the additional content, the embodiments disclosed herein can identify whether metadata for the additional content has already been generated when the additional content is received again for the same content stream or another content stream, and assess whether the additional content is to be stitched into the content stream based on the metadata. As another example, by generating metadata based on a portion of the additional content (e.g. selected frames of the additional content), the embodiments described herein can help reduce the amount of data needed to be processed by one or more machine learning or artificial intelligence models to generate metadata for the additional content. Additionally, in cases where metadata is to be generated, the embodiments disclosed herein are able to cause other additional content to be played while metadata is generated for the additional content. Thus, the presentation of content to the viewer via the content stream is uninterrupted by loading times associated with generating metadata for additional content, determining whether additional content is to be stitched into the content stream, or some combination thereof. Furthermore, the embodiments disclosed herein are able to adjust the order that additional content is presented based on the metadata, instead of simply playing the additional content as it is received like conventional content stream providers.

Unless the context requires otherwise, throughout the specification and claims which follow, the word “comprise” and variations thereof, such as, “comprises” and “comprising” are to be construed in an open, inclusive sense, for example “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments, and references to “some embodiments,” “other embodiments,” “example embodiments,” “one embodiment,” “an embodiment,” etc., do not preclude the combination of the particular features, structures, or characteristics of any of the embodiments with any of the other embodiments described herein.

Throughout this specification and the claims, references to causing a device, such as a computing device or other device, to perform an action, execute instructions, receive data, transmit data, or be affected in some manner, may be made. One of ordinary skill in the art may recognize that a first device may cause a second device to be affected in any of the manners listed above by transmitting instructions to the second device, transmitting data to the second device, transmitting instructions or data to a third device that can communicate with the second device, presenting instructions to a user to affect the second device, taking other actions that affect the second device, or some combination thereof. In the embodiments described herein, any one or more of these methods may be used to cause a second device to be affected in some manner.

As used in this specification and the appended claims, the singular forms “a,” “an,” and “the” include plural referents unless the content clearly dictates otherwise. The term “or” is generally employed to include “and/or” unless the content clearly dictates otherwise. The term “and/or” is generally employed to include an inclusive or.

The headings and Abstract of the Disclosure provided herein are for convenience only and do not interpret the scope or meaning of the embodiments.

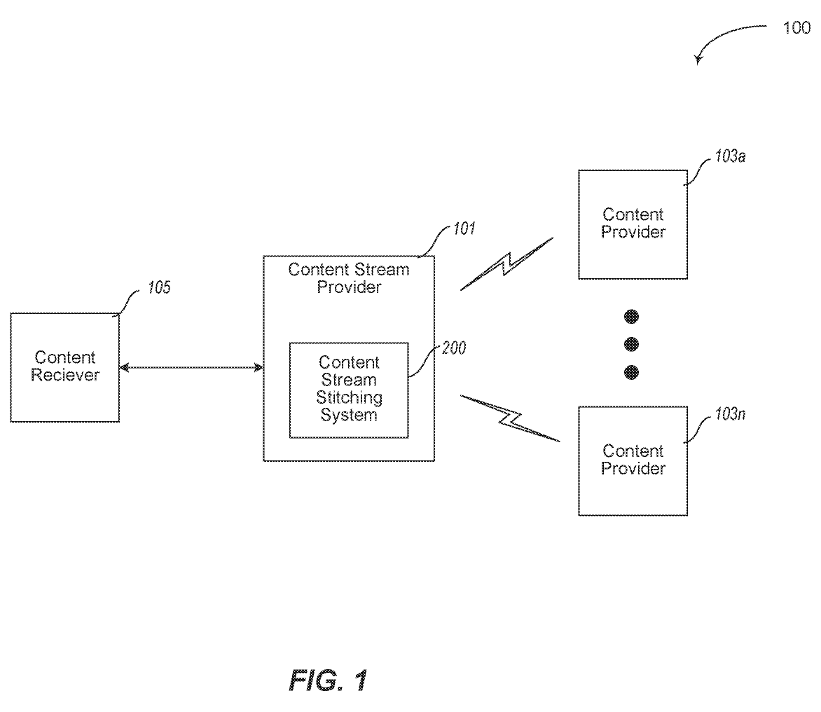

FIG. 1 is a display diagram depicting a sample environment 100 in which a content stream stitching system 200 operates, according to various embodiments described herein. The environment 100 includes a content stream provider 101, one or more content providers 103a-103n (collectively as “content providers 103” or individually as “content provider 103”), and a content receiver 105. The content stream provider 101 includes a content stream stitching system 200 (also referred to herein as a “content stitching system”). Although FIG. 1 depicts a content stream stitching system 200 being included as part of the content stream provider 101, embodiments are not so limited, and the content stream stitching system 200 may, in some embodiments, be included in a system separate from the content stream provider 101.

The content stream provider 101 generates and provides content streams to content receivers, such as a content receiver 105. The content streams may include television content, movie content, recorded content, website content, audio content (such as podcasts, music, radio content, other types of audio content, or some combination thereof), other types of media content, or some combination thereof. The content stream provider 101 may insert additional content into the content streams, such as by splitting a content stream at one or more selected points and inserting the additional content into the content stream at the one or more selected points (referred to herein as “stitching” content). The content stream provider 101 may receive media content, additional content, other content, or some combination thereof, from one or more content providers, such as the content providers 103. The content stream provider 101 may receive media content, additional content, other content, or some combination thereof. In some embodiments, the content stream provider 101 generates a content stream based on received content, stored content, or some combination thereof.

The content providers 103 may be one or more content providers that provide media content, additional content, or some combination thereof to a content stream provider, such as a content stream provider 101, a content receiver, such as the content receiver 105, or some combination thereof. Additional content may include advertisement content (such as an advertisement image, a video advertisement, an audio advertisement, other types of advertisement content, or some combination thereof), informative content (such as informational content promulgated by a government entity, an entity associated with the content receiver – e.g. a company, person, property management system or entity, etc.), or other types of content that is able to be stitched into a content stream generated by the content stream provider 101.

The content receiver 105 may be a device that receives a content stream from the content stream provider and provides content included in the content stream to a content presentation device (not shown). For example, a content receiver 105 may receive a content stream including television or other content via an internet connection, a broadcast receiver, a satellite receiver, recordings stored within the content receiver, other sources of content, or some combination thereof. A content receiver 105 may be or include: a set-top box, a satellite receiver, a broadcast receiver, a digital video recording device, a content presentation device, a smart phone, a tablet, a computer, other user devices able to receive content, or some combination thereof. In some embodiments, a content receiver 105 is able to communicate with one or more content providers 103 to receive content that is to be presented to a user.

The content stream provider 101; content providers 103; content receiver 105; content presentation devices (not shown); the system 200; other devices; or a combination thereof, may access a wired or wireless network. The network may be a network, communication system, or networked system (not shown), to which the system 200, content stream provider 101, content providers 103, content receiver 105, content presentation devices, other devices, or some combination thereof may be coupled. Non-limiting examples of such a network or communication system include, but are not limited to, an Ethernet system, twisted pair Ethernet system, an intranet, a local area network (LAN) system, short range wireless network (e.g., Bluetooth®), a personal area network (e.g., a Zigbee network based on the IEEE 802.15.4 specification), a Consumer Electronics Control (CEC) communication system, Wi-Fi, satellite communication systems and networks, cellular networks, cable networks, or the like. A content presentation device may be one or more endpoint devices, such as televisions, projectors, PCs, tablets, laptop computers, smartphones, personal assistants, drones, Internet connection devices, vehicles, USB dongles, Mi-Fi devices, wireless LAN, Wi-Fi, Worldwide Interoperability for Microwave Access (WiMax) devices, or the like, and may be communicatively coupled to the network or to each other so that the plurality of endpoint devices are communicatively coupled together.

The content stream stitching system 200 may communicate with the content stream provider 101, content providers 103, content receiver 105, content presentation devices, other devices, or a combination thereof. The content stream stitching system 200 may receive additional content that is to be stitched into a content stream provided to a content receiver 105 and stitch the additional content into the content stream. In some embodiments, the content stitching system 200 alters the order of content stitched into the content stream, adds content to the content stream, removes content from the content stream, prevents content from being stitched into the content stream, manipulates content stitched into the content stream, etc., based on one or more content criterions. In some embodiments, the content stitching system generates metadata for additional content that indicates one or more attributes of one or more elements of the additional content. In such embodiments, the content stitching system may alter the order of, add, remove, manipulate, prevent the inclusion of, etc., content stitched into the content stream based on the metadata and one or more content criterions.

In an example embodiment, a video streaming service provider (i.e. a content stream provider 101) that includes a content stream stitching system 200 may provide a stream including media content requested by a viewer to a content receiver. At a selected location within the video stream, the video streaming service provider may decide to insert additional content received from one or more content providers into the video stream. The video streaming service provider may determine whether metadata associated with one or more attributes of content elements included in first additional content, such as a commercial, has already been obtained. Based on a determination that the metadata has not been obtained, the video streaming service provider obtains or generates the metadata. While the metadata is being obtained, the video streaming service provider may identify second additional content that is to be included into the video stream, and may cause the second additional content to be transmitted to the content receiver in the place of the first additional content. After the metadata is obtained, the video streaming service provider may use the metadata and one or more selected content criterions to determine whether the first additional content is to be included into the content stream. Based on a determination that the first additional content is to be included in the content stream, the video streaming service provider stitches the first additional content into the content stream. Based on a determination that the first additional content is not to be included into the content stream, the video streaming service provider prevents the first additional content from being stitched into the content stream.

In another example embodiment, a viewer may be viewing a content stream associated with a television show. When the content stream reaches an advertisement break, advertisements are received from one or more content providers. The content stitching system determines whether metadata associated with the advertisements has already been generated. If metadata has not already been generated for one or more of the advertisements, the content stream stitching system 200 generates the metadata for the one or more advertisements. The content stream stitching system determines whether each of the advertisements should be included in the advertisement break based on the metadata generated for the advertisements and one or more content criterions for including advertisements into the content stream (e.g. whether the advertisements include subject matter inappropriate for an intended audience of the television show, whether the advertisements are in the same language as the television show, whether one or more actors appear in the advertisements, etc.). For each advertisement that is determined to be included in the content stream, the content stream stitching system stitches the advertisement into the content stream such that it is presented to a viewer during the advertisement break.

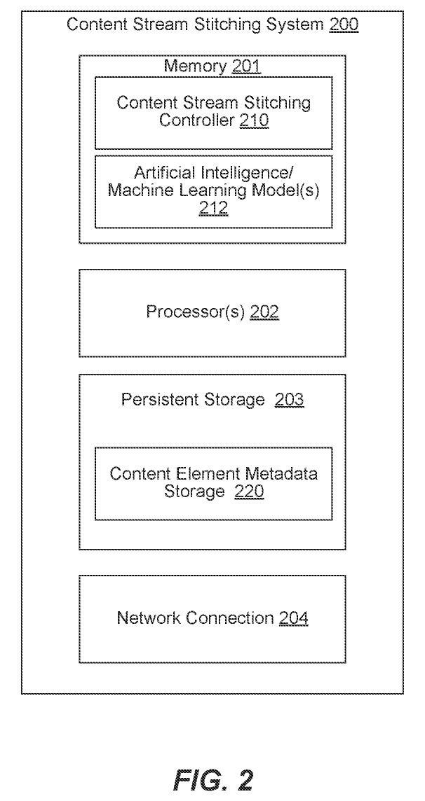

FIG. 2 is a block diagram depicting example components incorporated in a content stream stitching system 200, according to various embodiments described herein. One or more aspects of the content stream stitching system 200 (“the system 200”) may be implemented or integrated on or in a content stream provider (such as a content stream provider 101), content receiver (such as a content receiver 105), content provider (such as a content provider 103), user device, one or more devices, one or more servers, or some combination thereof.

In various embodiments, the system 200 includes one or more of the following: a computer memory 201, a processor 202, a persistent storage device 203, and a network connection 204. The memory 201 may be used for storing programs and data while they are being used, including data associated with the system 200, content receivers, content presentation devices, users, other devices, an organization, an operating system including a kernel (not shown), device drivers (not shown), and one or more machine learning models. The processor 202 may be used for executing computer programs (not shown), such as computer programs which perform some or all of the functions of the system 200. In some embodiments, the processor 202 may be one or more processors, microcontrollers, or other computer components. In some embodiments, any of the processors, microcontrollers, or other computer components, either alone or in combination, can perform any of the functions or acts described herein. The persistent storage device 203 may be a hard drive or flash drive for persistently storing programs and data. The network connection 204 may be used for connecting to one or more networks associated with the organization, content receivers, content presentation devices, or other computer systems (not shown), to send or receive data, such as via the Internet or another network and associated networking hardware, such as switches, routers, repeaters, electrical cables and optical fibers, light emitters and receivers, radio transmitters and receivers, and the like, and to scan for and retrieve signals associated with content presentation devices, content receivers, other devices, a content stream stitching system, and for connecting to one or more computer devices such as content presentation devices, content receivers, a content stream stitching system, other devices or components associated with an organization associated with the content stream stitching system, or other computer systems. In various embodiments, the system 200 additionally includes input and output devices, such as a keyboard, a mouse, display devices, etc.

While a system 200 configured as described may be used in some embodiments, in various other embodiments, the system 200 may be implemented using devices of various types and configurations and having various components. The memory 201 may include a content stream stitching controller 210, which contains computer-executable instructions that, when executed by the CPU 202, cause the system 200 to perform the operations and functions described herein. For example, the programs referenced above, which may be stored in computer memory 201, may include or be comprised of such computer-executable instructions. The memory 201 may include one or more artificial intelligence or machine learning models 212 that may be used to generate a text description of one or more aspects of additional content, generate metadata regarding additional content (such as metadata indicating attributes of one or more elements of the additional content), or some combination thereof.

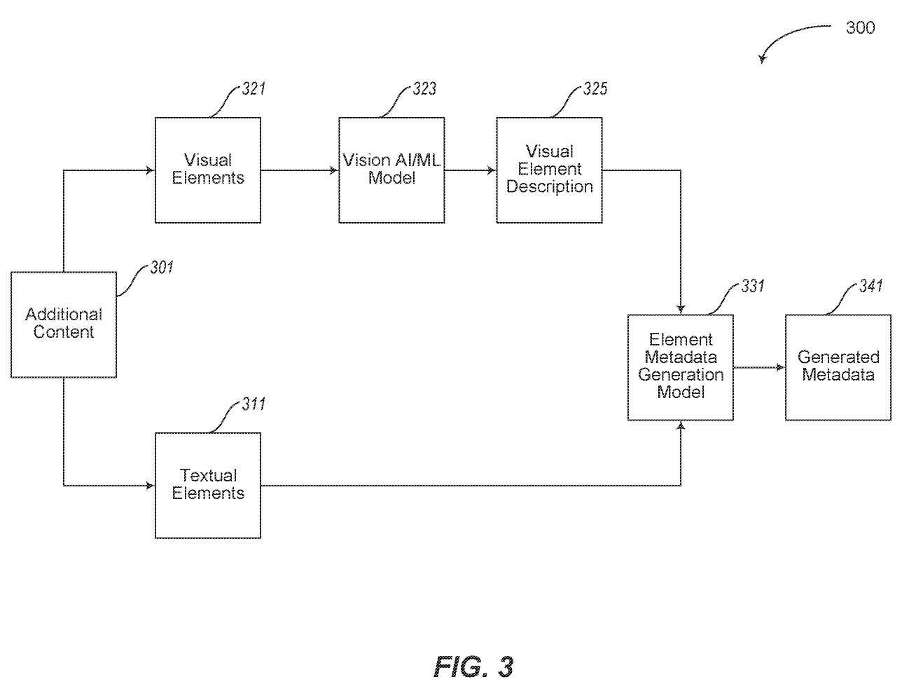

The content stream stitching controller 210 (the “controller 210”) performs the core functions of the system 200, as discussed herein and also with respect to FIGS. 3-5. In an example embodiment, the system 200 and the controller 210 are included in a content stream provider 101, and the content stream provider performs the core functions of the system 200. In particular, the controller 210 determines whether additional content is to be stitched into a content stream based on metadata of the additional content and one or more content criterions. Additionally, the controller 210 may generate metadata indicating one or more attributes of one or more content elements of the additional content, such as by using the artificial intelligence and machine learning models 212. In some embodiments, the controller 210 receives the additional content from a content provider 103. In some embodiments, the controller 210 receives an indication of one or more content criterions from a user of a content receiver, an entity associated with the content stream provider, an entity associated with a content provider, other entities, or some combination thereof. In some embodiments, the controller 210 stitches second additional content to the content stream at a location at which the first additional content was to be stitched while metadata for the first additional content is identified, generated, etc. In such embodiments, the controller 210 may identify metadata for the first additional content during a time period at which a user device associated with the content receiver is to present the second additional content. In some embodiments, the controller 210 may generate a unique identifier for additional content.

In an example embodiment, the controller 210 or computer-executable instructions stored on memory 201 of the system 200 are implemented using standard programming techniques. For example, the controller 210 or computer-executable instructions stored on memory 201 of the system 200 may be implemented as a “native” executable running on CPU 202, along with one or more static or dynamic libraries. In other embodiments, the controller 210 or computer-executable instructions stored on memory 201 of the system 200 may be implemented as instructions processed by a virtual machine that executes as some other program.

The embodiments described above may also use synchronous or asynchronous client-server computing techniques. However, the various components may be implemented using more monolithic programming techniques as well, for example, as an executable running on a single processor computer system, or alternatively decomposed using a variety of structuring techniques known in the art, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented or performed by each component/module, and in different orders, and by different components/modules, yet still achieve the functions of the controller 200.

In addition, programming interfaces to the data stored as part of the controller 210 can be available by standard mechanisms such as through C, C++, C#, Java, Golang, and web APIs; libraries for accessing files, databases, or other data repositories; through scripting languages such as JavaScript and VBScript; or through Web servers, FTP servers, or other types of servers providing access to stored data. The controller 210 may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of the system 200.

Furthermore, in some embodiments, some or all of the components/portions of the controller 210, or functionality provided by the computer-executable instructions stored on memory 201 of the system 200 may be implemented or provided in other manners, such as at least partially in firmware or hardware, including, but not limited to, one or more application-specific integrated circuits (ASICs), standard integrated circuits, controllers (e.g., by executing appropriate instructions, and including microcontrollers or embedded controllers), field-programmable gate arrays (FPGAs), complex programmable logic devices (CPLDs), and the like. Some or all of the system components or data structures may also be stored as contents (e.g., as executable or other machine-readable software instructions or structured data) on a computer-readable medium (e.g., as a hard disk; a memory; a computer network or cellular wireless network; or a portable media article to be read by an appropriate drive or via an appropriate connection, such as a DVD or flash memory device) so as to enable or configure the computer-readable medium or one or more associated computing systems or devices to execute or otherwise use or provide the contents to perform at least some of the described techniques. Such computer program products may also take other forms in other embodiments. Accordingly, embodiments of this disclosure may be practiced with other computer system configurations.

In general, a range of programming languages may be employed for implementing any of the functionality of the content presentation devices; system 200; systems, applications, and functions, of the organization; etc., present in the example embodiments, including representative implementations of various programming language paradigms and platforms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, PHP, Python, JavaScript, VBScript, and the like) and declarative (e.g., SQL, Prolog, and the like).

The artificial intelligence or machine learning models 212 (the “models 212”) may include be or include one or more artificial intelligence or machine learning models. For example, the models 212 may include one or more vision models trained to generate a text description of one or more videos, images, video frames, etc. The one or more vision models may be trained based on a training dataset that includes videos, images, video frames, etc., and text descriptions of the videos, images, video frames, etc. The models 212 may include one or more element metadata generation models trained to identify attributes of one or more elements of additional content based on a text description of the additional content. The one or more element metadata generation models may be trained based on a training dataset that includes text descriptions of one or more instances of additional content and attributes of elements of the instances of additional content. In some embodiments, the output of the one or more vision models is used to train the one or more element metadata generation models. In some embodiments, the content stream provider receives viewer feedback regarding additional content presented to a viewer. In such embodiments, the viewer feedback may be used to generate additional training data for the one or more element metadata generation models. For example, viewer feedback may indicate that an instance of additional content was inappropriate to be presented to the viewer because the content included a particular illicit substance. The viewer feedback and instance of additional content may be used to train the element metadata generation model to recognize that illicit substance and generate metadata indicating that additional content includes that particular illicit substance. In some embodiments, the models 212 include at least one vision model and at least on element metadata generation model.

In some embodiments, one or more of the models 212 are generative artificial intelligence models, such as GPT, Llama, DALL-E, etc. In some such embodiments, one or more of the models 212 may be trained or configured to receive a prompt in addition to other input in order to generate their output. For example, a vision model may receive one or more images, video frames, videos, or some combination thereof (collectively “visual media”) as well as a prompt that requests that the vision model describe the visual media, identify logos included in the visual media, identify taglines included in the visual media, identify entities included in the visual media, identify objects included in the visual media, identify other attributes of elements of the visual media, or some combination thereof. In another example, an element metadata generation model may receive text descriptions of one or more instances of additional content as well as a prompt that requests that the element metadata generation model generate one or more words or phrases that indicate attributes of the additional content, such as one or more entities, a brand, a content category of the additional content, one or more websites, other attributes of elements of additional content, or some combination thereof. In an example embodiment where the models 212 include at least one vision model and at least one generative artificial intelligence model, the system 200 is able to use both the textual elements of the additional content and the visual elements of the additional content to generate the metadata for the additional content. By using models configured to analyze textual data and models configured to analyze visual data (i.e. images, video frames, video, etc.), the system 200 is able to generate metadata quickly and more accurately than models that are configured to analyze the entirety of additional content (i.e. an entire video).

The persistent storage 203 may include content element metadata storage 220. The content element metadata storage 220 may be a data store, database, etc., that stores metadata generated for additional content and a unique identifier associated with the additional content. The system 200 may use the content element metadata storage 220 to determine whether metadata for additional content received from a content provider 103 has already been generated. The system 200 may obtain metadata regarding additional content whose metadata has already been generated from the content element metadata storage 220.

In some embodiments, aspects of the system 200 may be implemented in an application executed by a content receiver (such as the content receiver 105 described above with respect to FIG. 1), content stream provider (such as the content stream provider 101 described above with respect to FIG. 1), content provider (such as the content provider 103, described above with respect to FIG. 1), a content presentation device associated with a content receiver, or some combination thereof. In some such embodiments, some of the functions of the system 200, may be performed by a computing device via execution of the application.

The operation of certain aspects will now be described with respect to FIGS. 3-5. In at least one of various embodiments, at least a portion of the data flow 300 and processes 400 and 500 described in conjunction with FIGS. 3, 4, and 5, respectively, may be implemented by one or more processors or executed via circuitry on one or more computing devices described in connection with FIG. 2, the content stream provider 101 described in connection with FIG. 1, content receiver 105 described in connection with FIG. 1, content provider 103 described in connection in FIG. 1, a content presentation devices associated with a content receiver, other computing devices, or some combination thereof.

Furthermore, aspects of the processes 300-500 may cause a content receiver (such as the content receiver 105 described above with respect to FIG. 1), content stream provider (such as the content stream provider 101 described above with respect to FIG. 1), a content stream stitching system (such as the system 200, described above with respect to FIGS. 1 and 2), content provider (such as the content provider 103, described above with respect to FIG. 1), content presentation device associated with a content receiver, another computing device, or some combination thereof to take an action, such as receiving data, displaying certain data, altering the display of data, transmitting data, other actions, or some combination thereof. In some embodiments, causing a content receiver, content provider, content stream provider, content presentation device, the system 200, or another device to take an action includes transmitting commands, instructions, etc., to take the action to the content receiver, content provider, content stream provider, content presentation device, the system 200, or another device, such as by transmitting instructions, commands, etc., from the system or device to another system or device.

FIG. 3 is a data flow diagram depicting a sample data flow 300 for generating metadata for additional content, according to various embodiments described herein. In the data flow 300, additional content 301 is received by a content stitching system, such as the content stitching system 200, described above in connection with FIG. 2.

The content stitching system extracts visual elements 321 and textual elements 311 from the additional content. In some embodiments, as part of extracting the visual elements 321 and textual elements 311, the content stitching system extracts audio data, image data, video data, textual data, or some combination thereof, from the additional content 301. In some embodiments the content stitching system extracts textual elements 311 by generating a transcript of audio data for at least a portion of the additional content 301. In such embodiments, the content stitching system may generate the transcript by applying one or more speech-to-text models, algorithms, systems, etc., to the audio. In some embodiments, the content stitching system extracts textual elements 311 from textual data included in the additional content 301.

In some embodiments, visual elements 321 are extracted from image data, video data, other visual data, or some combination thereof. In some embodiments, where the additional content 301 includes video data, the content switching system selects one or more frames from the video data and designates those frames as the visual elements 321. In some embodiments, the content switching system selects one or more frames based on a random selection of frames, based on a threshold number of frames, based on one or more selected positions or timestamps within the video data, other methods of selecting frames, or some combination thereof.

In some embodiments, the additional content 301 does not include textual elements. In such embodiments, the content stream stitching system does not extract textual elements 311 from the additional content 301. In some embodiments, the additional content 301 does not include visual elements 312. In such embodiments, the content stream stitching system does not extract visual elements 321 from the additional content 301. For example, in embodiments where the additional content is a video advertisement, the content stream stitching system may extract textual elements 311 and visual elements 321 from the additional content 301. As another example, where the additional content is an audio advertisement, the content stream stitching system may extract textual elements 311 but not visual elements 321. As yet another example, where the additional content is a banner advertisement, such as an advertisement on a website, the content stream stitching system may extract visual elements 321 but not textual elements 311.

The content stitching system applies a vision artificial intelligence or machine learning model 323 to the visual elements 321. In some embodiments the vision model 323 includes one or more of the models 212, such as the vision model, described above in connection with FIG. 2.

The content stitching system receives from the artificial intelligence or machine learning model 323 one or more visual element descriptions 325. In some embodiments, the visual element descriptions 325 includes text data indicating attributes of one or more visual elements included in the visual elements 321. In such embodiments, the attributes may include: a description of one or more images included in the visual elements 321, an indication of an entity (such as a person, company, group, or other type of entity), an indication of a geographic area within which the one or more images were obtained, an indication of one or more objects included in the one or more images, an indication of one or more logos included in the one or more images, an indication of one or more “taglines” included in the one or more images, an indication of text included in the one or more images, an indication of one or more other elements or attributes of the images included in the visual elements 321, or some combination thereof.

The content stitching system applies an element metadata generation model 331 to the textual elements 311 and the visual element description 325. In some embodiments, the element metadata generation model 331 includes one or more of the models 212, such as an element metadata generation model, described above in connection with FIG. 2. In some embodiments, the content stitching system combines the textual elements 311 and visual element description 325 before applying the element metadata generation model 331 to them. In such embodiments, the content stitching system may concatenate text data representing the textual elements 311 and text data representing the visual element description 325 as part of combining the textual elements 311 and visual element description 325.

The content stitching system receives generated metadata 341 from the element metadata generation model 331. In some embodiments, the generated metadata includes metadata regarding attributes of elements of the instance of additional content, such as: a content category of the additional content 301; one or more languages present in the additional content 301; one or more companies, people, brands, websites, other types of entities, or some combination thereof, referenced in the additional content 301; one or more thematic elements associated with the additional content 301; one or more objects identified in the additional content 301; one or more geographic regions included in, referenced by, relating to, etc., the additional content 301; a brand, company, people, website, other type of entity, or some combination thereof, on behalf of which the additional content 301 is presented; other types of metadata associated with the content elements of additional content; or some combination thereof.

In some embodiments, the content stitching system saves the generated metadata 341 in a database that stores metadata generated for additional content. In some embodiments, the content stitching system generates a unique identifier for the generated metadata 341. In such embodiments, the content stitching system may generate the unique identifier for the generated metadata based on a location or source from which the additional content was received, a value generated based on the data included in the additional content (such as, for example, a checksum), other data useful for generating a unique identifier for additional content, or some combination thereof.

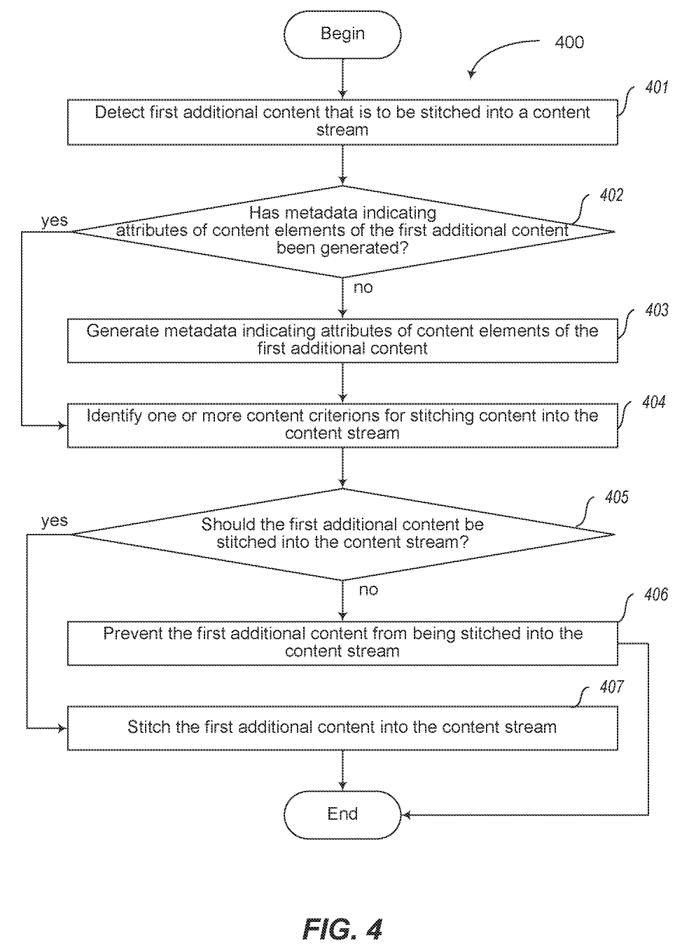

FIG. 4 is a flow diagram of a process 400 for stitching additional content into a content stream based on one or more content criterions, according to various embodiments described herein.

The process 400 begins, after a start block, at act 401, where a content stitching system detects first additional content that is to be stitched into a content stream. In some embodiments, the content stitching system performs act 401 while a content stream is being provided to a content receiver for presentation to a user. In some embodiments, the system performs act 401 while the content stream is being prepared for transmission to a content receiver, such as while a content stream provider prepares or generates the content stream.

The process 400 proceeds to act 402, where the content stitching system determines whether metadata indicating attributes of content elements of the first additional content has already been generated. In some embodiments, the content stitching system performs act 402 by generating a unique identifier for the additional content and determining whether metadata of the first additional content has been generated based on the unique identifier. For example, the content stitching system may determine whether the unique identifier is present in a data store for storing metadata for additional content. Based on a determination that the unique identifier is present, the content stitching system may determine that the metadata has already been generated. Likewise, based on a determination that the unique identifier is not present, the content stitching system may determine that the metadata has not already been generated. In such embodiments, the content stitching system may generate the unique identifier in a similar manner to generating the unique identifier for generated metadata, described above in connection with FIG. 3.

If the content stitching system determines that the metadata has already been generated, the process 400 proceeds to act 404, otherwise, the process 400 proceeds to act 403.

At act 403, the content stitching system generates metadata indicating attributes of content elements of the first additional content. In some embodiments, to generate the metadata, the content stitching system uses at least a portion of the process described above in connection with the data flow diagram 300.

At act 404, the content stitching system identifies one or more content criterions for stitching content into the content stream. In some embodiments, the one or more content criterions include: one or more excluded categories of content; one or more viewer age restrictions; one or more viewer age restrictions for one or more content categories; at least one order for stitching content into a content stream; one or more rules for determining an order for stitching content into a content stream; at least one threshold number of times an instance of content is to be stitched into a content stream; at least one language restriction for content stitched into a content stream; one or more rules regarding the inclusion or exclusion of content in which one or more entities appear; a length of time for presenting the content; whether the content is presented in one or more geographic areas; other criterions for stitching content into the content stream; or some combination thereof. In some embodiments, one or more of the content criterions are defined by an entity associated with the content stream provider, an entity associated with a content provider, an entity associated with the content receiver, an entity associated with a content presentation device, a user associated with a content receiver that is currently receiving the content stream, or some combination thereof. For example, one or more content criterions may be specified by a content stream provider. In another example, one or more content criterions may be specified via user input received by a content receiver. In yet another example, one or more content criterions may be specified by a content stream provider and one or more additional content criterions may be received via user input received by a content receiver. In such an example, the content stream stitching system may identify both the content criterions specified by the content stream provider and the content criterions received via user input as part of performing act 404.

The process 400 proceeds to act 405, where the content stitching system determines whether the first additional content should be stitched into the content stream. In some embodiments, the content stitching system determines whether the first additional content should be stitched into the content stream based on the one or more content criterions and the metadata for the first additional content. For example, if the metadata indicates that the content category of the first additional content is alcoholic drinks, and the content being streamed is a program for children, the content stitching system may determine, based on content criterions that indicate that content regarding alcohol should not be presented during children’s programs and the metadata, that the first additional content should not be stitched into the content stream. In some embodiments, the content stitching system determines the placement for the first additional content within the content stream based on the metadata for the first additional content, the content criterions, metadata for other additional content, or some combination thereof.

If the first additional content should be stitched into the content stream, the process 400 proceeds to act 407, otherwise the process 400 proceeds to act 406.

At act 406, the content stitching system prevents the first additional content from being stitched into the content stream. After act 406, the process 400 ends. In some embodiments, the content stream stitching system prevents the first additional content from being stitched into the content stream by stitching additional content other than the first additional content into the content stream. In some embodiments, preventing the first additional content from being stitched into the content stream includes ensuring, by the content stream stitching system, that the first additional content is not stitched into the content stream, such as by not stitching the first additional content into the content stream. In some embodiments, when the content stream stitching system doesn’t stitch the first additional content into the content stream, the content stream stitching system stitches other additional content into the content stream. In some embodiments, the content stitching system may determine a different location within the content stream to include the first additional content instead of preventing the first additional content from being stitched into the content stream. In such embodiments, the content stitching system may determine the different location for stitching the first additional content based on metadata for other additional content stitched into the content stream, metadata for the first additional content, one or more content criterions, or some combination thereof. For example, the first additional content may be an advertisement for a first car company, and a second additional content may be an advertisement for a second car company. In such an example, the two car companies may require that their advertisements are not presented one after the other in a content stream, and the content stitching system may stitch third additional content into the content stream between the first and second additional content to ensure that this content criterion is met.

At act 407, the content stitching system stitches the first additional content into the content stream. In some embodiments, the content stitching system performs act 407 while a content stream is being provided to a content receiver for presentation to a user. In some embodiments, the system performs act 407 while the content stream is being prepared for transmission to a content receiver, such as while a content stream provider prepares or generates the content stream. As a result of stitching the first additional content to the content stream at a first point in the content stream, a recipient of the content stream is caused to present the first additional content at the first point in the content stream before presenting the media content included in the content stream after the first point in the content stream. After act 407, the process 400 ends.

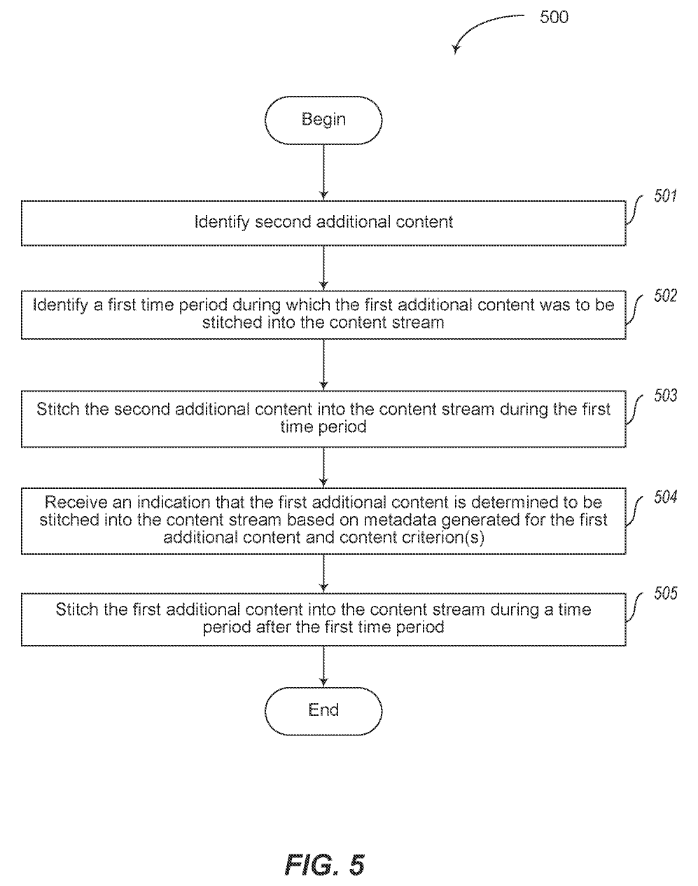

FIG. 5 is a flow diagram of a process 500 for causing second additional content to be stitched into a content stream while metadata is being generated for first additional content, according to various embodiments described herein. In some embodiments, the content stitching system performs the process 500 when the content stitching system detects that metadata indicating attributes of elements of first additional content has not been generated or is not accessible to the content stitching system.

The process 500 begins, after a start block, at act 501, where the content stitching system identifies second additional content. In some embodiments, the content stitching system determines whether the second additional content can be stitched into the content stream, such as by using at least a portion of the process 400 described above in connection with FIG. 4. In such embodiments, if the second additional content cannot be stitched into the content stream, the content stitching system may continue to identify additional content until additional content that can be stitched into the content stream is identified.

The process 500 proceeds to act 502, where the content stitching system identifies a first time period during which the first additional content was to be stitched into the content stream. For example, the first additional content may have been intended to be played during the first fifteen seconds of a content break.

The process 500 proceeds to act 503, where the content stitching system stitches the second additional content into the content stream during the first time period. Continuing the example above in connection with act 502, the content stitching system instead stitches the content stream such that the second additional content plays within the first fifteen seconds of the content break. Furthermore, in such an example, the content stitching system may continue to perform the process 500 while the second additional content is being played (i.e. during the first fifteen seconds of the content break). By operating in this manner, the content stitching system would be able to determine whether the first additional content can be stitched into the content stream without interrupting the presentation of content to the user because the second additional content is stitched into the content stream while the content stitching system determines whether first additional content is able to be stitched into the content stream, such as by performing one or more aspects of the process 400, described above in connection with FIG. 4.

The process 500 proceeds to act 504, where the content stitching system receives an indication that the first additional content is determined to be stitched into the content stream based on metadata generated for the first additional content and one or more content criterions. In some embodiments, the content stitching system receives the indication that the first additional content is determined to be stitched into the content stream as a result of performing one or more aspects of the process 400, described above in connection with FIG. 4.

The process 500 proceeds to act 505, where the content stitching system stitches the first additional content into the content stream during a time period after the first time period. Continuing the example above in connection with act 503, if the first additional content is determined to be suitable to stitch into the content stream, the content stream stitching system is able to stitch the first additional content such that it is presented after the second additional content (i.e. after the first fifteen seconds of the content break in this example).

After act 505, the process 500 ends.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
at least one processor;
at least one memory coupled to the at least one processor, the memory having computer-executable instructions stored thereon that, when executed by the at least one processor, cause the system to:
transmit a content stream including media content to a user device;
detect that first additional content is to be stitched to the content stream;
determine whether metadata indicating attributes of content elements included in the first additional content has already been generated;
based on a determination that the metadata has not already been generated:
generate a text description of the first additional content by subjecting at least a portion of the first additional content to a first machine learning model configured to generate a text description of content based on at least a portion of content; and
generate metadata of the first additional content by subjecting the text description to a second machine learning model configured to generate metadata for content based on a text description of content;
identify one or more content criterions for stitching content to the content stream;
determine whether the first additional content is to be stitched to the content stream based on the one or more content criterions and the metadata; and
based on a determination that the first additional content is to be stitched to the content stream, cause the user device to present the first additional content by stitching the first additional content to the content stream.

2. The system of claim 1, wherein the one or more content criterions comprise:
at least one viewer age restriction for one or more content categories;
at least one order for stitching content into a content stream;
at least one threshold number of times an instance of content is to be stitched into a content stream; or
at least one language restriction for content stitched into the content stream.

3. The system of claim 1, wherein the computer-executable instructions, when executed by the at least one processor, further cause the system to:
generate a unique identifier for the first additional content; and
store the generated metadata in a content metadata database based on the unique identifier.

4. The system of claim 3, wherein the computer-executable instructions, when executed by the at least one processor to generate the unique identifier, further cause the system to:
identify a source from which the first additional content was received;
generate a value based on data indicating the first additional content; and
generate the unique identifier for the first additional content based on the identified location and the generated value.

5. The system of claim 1, wherein, based on a determination that the metadata has not already been generated, the computer-executable instructions, when executed by the at least one processor to, further cause the system to:
identify second additional content that is to be stitched to the content; and
stitch the second additional content to the content stream before the first additional content, wherein the user device receiving the content stream is caused to present the second additional content before the first additional content.

6. The system of claim 5, wherein, during a time period during which the second additional content is to be presented, the system is caused to:
generate the text description of the first additional content; and
generate the metadata of the first additional content.

7. The system of claim 1, wherein, to generate the text description of the first additional content, the computer-executable instructions, when executed by the at least one processor to, further cause the system to:
generate first text based on audio included in the first additional content;
generate second text by applying a third machine learning model to one or more video frames of the first additional content, the third machine learning model being configured to generate a text description of one or more images based on one or more images; and
generate the text description of the first additional content based on the first text and the second text.

8. The system of claim 1, wherein the user device is a content receiver.

9. A method comprising:
transmitting a content stream including media content to a content receiver;
detecting that first additional content is to be stitched to the content stream;
generating a text description of the first additional content by applying a first machine learning model to at least a portion of the first additional content, the first machine learning model being configured to generate a text description of content based on at least a portion of content;
generating metadata for the first additional content by applying a second machine learning model to the text description, the second machine learning model being configured to generate metadata for content based on a text description of content;
identifying one or more content criterions for stitching content to the content stream;
determining whether the first additional content is to be stitched to the content stream based on the one or more content criterions and the metadata; and
based on a determination that the first additional content is to be stitched to the content stream, stitching the first additional content to the content stream.

10. The method of claim 9, further comprising:
generating a unique identifier for the first additional content; and
storing the generated metadata in a content metadata database based on the unique identifier.

11. The method of claim 10, wherein generating the unique identifier comprises:
identifying a location from which the first additional content was received;
generating a value based on the data included in the first additional content; and
generating a unique identifier for the first additional content based on the identified location and the generated value.

12. The method of claim 9, further comprising:
identifying second additional content that is to be presented after the first additional content; and
stitching the second additional content to the content stream before the first additional content, wherein the content receiver is caused to present the second additional content before the first additional content.

13. The method of claim 12, wherein, generating the metadata for the first additional content occurs during a time period during which the second additional content is to be presented.

14. The method of claim 9, wherein generating the text description of the first additional content comprises:
generating first text based on audio included in the first additional content;
generating second text by applying a third machine learning model to one or more video frames of the first additional content, the third machine learning model being configured to generate a text description of one or more images based on one or more images; and
generating the text description of the first additional content based on the first text and the second text.

15. A non-transitory processor readable storage medium storing instructions that, when executed by one or more processors, cause the one or more processors to perform a method comprising:
detecting that first additional content is to be stitched to a content stream;
generating metadata for the first additional content based on a text description describing at least a portion of the first additional content by applying a machine learning model configured to generate metadata for content to the text description describing at least a portion of the first additional content;
identifying one or more content criterions for stitching content to the content stream;
determining whether the first additional content is to be stitched to the content stream based on the one or more content criterions and the metadata; and
based on a determination that the first additional content is not to be stitched to the content stream, preventing the first additional content from being stitched to the content stream.

16. The non-transitory processor readable storage medium of claim 15, the method further comprising:
generating a unique identifier for the first additional content; and
storing the generated metadata in a content metadata database based on the unique identifier.

17. The non-transitory processor readable storage medium of claim 16, wherein generating the unique identifier comprises:
identifying a location from which the first additional content was received;
generating a value based on the data included in the first additional content; and
generating a unique identifier for the first additional content based on the identified location and the generated value.

18. The non-transitory processor readable storage medium of claim 15, the method further comprising:
identifying second additional content that is to be presented during a second time period that occurs after a first time period during which the first additional content was to be presented; and
stitching the second additional content to the content stream, wherein the second additional content is caused to be presented during the first time period instead of the first additional content.

19. The method of claim 18, wherein, generating the metadata for the first additional content occurs during the first time period.

20. The non-transitory processor readable storage medium of claim 15, the method further comprising:
generating first text based on audio included in the first additional content;
generating second text by applying a third machine learning model to one or more video frames of the first additional content, the third machine learning model being configured to generate a text description of one or more images based on one or more images; and
generating the text description of the first additional content based on the first text and the second text.
